(19) United States
(12) Patent Application Publication
(10) Pub. No.: US 2005/0031740 A1
(43) Pub. Date: Feb. 10, 2005

(54) Method for presentation and service of food or treats for companions

(76) Inventor: Renee Weigert, Rolling Meadows, IL (US)

Correspondence Address: FRANK C. NICHOLAS;CARDINAL LAW GROUP, Suite 2000, 1603 Orrington Avenue, Evanston, IL, 60201, US

(21) Appl. No.: 10/913,113

(22) Filed: Aug. 6, 2004

Related U.S. Application Data
(60) Provisional application No. 60/481,193, filed on Aug. 7, 2003.
(60) Provisional application No. 60/515,799, filed on Oct. 30, 2003.

(51) Int. Cl. A21D 8/00

(52) U.S. Cl. 426/106

(57) ABSTRACT

A method for packaging treats for companions is provided. The method includes providing a pizza not intended for human consumption and packaging the pizza not intended for human consumption in a pizza delivery box. A method for packaging treats for companions is provided. The method includes providing a treat not intended for human consumption and packaging the treat not intended for human consumption in a form that requires further preparation prior to serving and providing instructions for the preparation.

### RELATED APPLICATIONS

This application claims the benefit of U.S. Provisional Patent Application 60/481,193 filed Aug. 7, 2003. This application further claims the benefit of U.S. Provisional Patent Application 60/515,799 filed Oct. 30, 2003.

### BACKGROUND OF INVENTION

The invention relates to a method for presentation of food or treats for non-human companions. More specifically, the invention relates to a method of presenting and serving a pizza comprising pet treats for dogs.

Many people have dogs and other pets and enjoy the companionship provided by their pets. As one aspect of the relationship, many people enjoy providing their pets treats. Treats are provided for a variety of reasons including rewards, encouragement for desirable behavior or just to provide a treat. In order to increase the enjoyment of giving treats, manufacturers have created treats in several novelty shapes and designs over the years. For example, dog treats are frequently made in the shape of a dog bone.

A novel method of presenting, serving and packaging dog treats is desirable. A novel dog treat is also desirable.

### SUMMARY OF THE INVENTION

One embodiment of the invention provides a method of presenting food not intended for human consumption. The method includes providing a crust; arranging a plurality of treats on the crust to form a pizza; wrapping the pizza; and packaging the wrapped pizza in a box.

Another embodiment of the invention provides a food item not intended for human consumption. The food item includes an inedible crust and a plurality of treats arranged on the crust. The food item further includes a box enclosing the crust and treats.

Yet another aspect of the invention provides a method of packaging treats not intended for human consumption. The method includes providing food not intended for human consumption and forming the food into an elongated food tube with a cross-section of a desired shape such that the elongated food tube comprises multiple servings. The method includes packaging the food; and providing instructions for preparation of the food, the instructions including a direction that the food is not intended for human consumption.

The foregoing and other features and advantages of the invention are apparent from the following detailed description of exemplary embodiments, read in conjunction with the accompanying drawings, which are not drawn to scale. The detailed description and drawings are merely illustrative of the invention rather than limiting, the scope of the invention being defined by the appended claims and equivalents thereof.

### DESCRIPTION OF THE DRAWINGS

FIG. 1 illustrates a method for presentation of food or treats for non-human companions in accordance with one aspect of the invention;

FIG. 2 illustrates a food not intended for human consumption in accordance with one aspect of the invention;

FIG. 3 illustrates a box for packaging the food not intended for human consumption in accordance with another aspect of the invention;

FIG. 4 illustrates the food not intended for human consumption of FIG. 2 disposed within the packaging box of FIG. 3;

FIG. 5 illustrates a method for presentation of food or treats for non-human companions in accordance with one aspect of the invention;

FIG. 6 illustrates a cross section of one embodiment of a product for presenting and serving food not intended for human consumption in accord with one embodiment of the invention; and

FIG. 7 illustrates another embodiment of a product for presenting and serving food not intended for human consumption in accord with one embodiment of the invention.

### DETAILED DESCRIPTION OF THE INVENTION

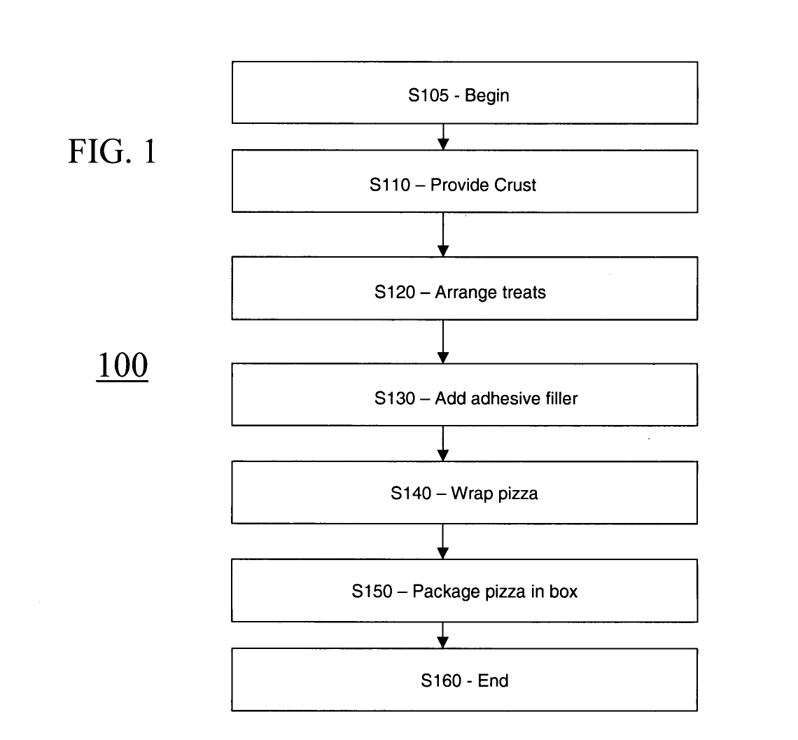

FIG. 1 illustrates a method in accordance with the instant invention at 100. Method 100 begins at S105.

At S110, a crust is provided. In one embodiment of the invention, the crust comprises inedible, but dog-friendly treat, such as rawhide or a bone or a bone-like substance. In one embodiment, the crust is a toy, such as a rubber toy, inflatable toy, or another dog toy as would be known to those of skill in the art. In another embodiment, the crust may be a plastic flying disc such as a Frisbee® brand flying disc available from Wham-O® Inc. of Emeryville, Calif. or other flying discs. In another embodiment of the invention, the crust may comprise a non-edible material such as wicker, plastic, a polymer, wood, or glass. In another embodiment, the crust comprises paper or cardboard. The crust, however, is not intended for human consumption. In one embodiment, the crust is substantially circular. In another embodiment, the crust is substantially rectangular. In another embodiment, the crust is substantially square. In another embodiment, the crust is another appropriate shape, such as, for example, a triangle, oval or other polygonal shape. In one example, the crust is substantially flat, without raised edges. In another example, the crust is thicker at the outer edge than in the inner portion of the crust, as in a deep-dish, or pan-styled, pizza. In another example, the crust is raised at the outer edge relative to the inner portion of the crust, as in a deep-dish, or pan-styled, pizza.

At S120, a plurality of treats is arranged upon the crust as toppings. The treats are arranged to convey the impression and visual appeal of a pizza intended for human consumption, while remaining comprised of dog treats that are not intended for human consumption. In one embodiment of the invention, the treats comprise a plurality of “kibbles” such as milk bones, pupparoni, dog sausages, or other appropriate dog treats. Dog treats shaped like a pizza intended for human consumption are added, in one embodiment, to further convey the desired visual impression. Other embodiments may entail using dog treats shaped like food intended for human consumption, such as a treat shaped like a pepperoni, mushroom, sausage, tomato or olive. The topping, in some embodiments, further comprises moist chewy chunks, kibbles, crunchy dog snacks, bits, bacon, Beggin Strips® and other dog treats as known to those of ordinary skill in the art. Inclusion or exclusion of particular treats is not an element of the invention, and the invention may be practiced with all of the above treats, some of the above treats, or treats entirely different from the above listed treats.

At S130, in one embodiment, adhesive filler may be added to adhere the treats to each other and to the crust. The adhesive filler is intended for consumption by the dog, but again, is not intended for human consumption. In one embodiment, the adhesive filler may comprise a “wet” dog food. In another embodiment, gelatin is used as an adhesive filler, and is applied to either the surface, or as an interstitial filler between toppings. In other embodiments, no adhesive filler is used, and the toppings are simply disposed upon the crust.

At S140, in one embodiment, the crust and toppings are wrapped in a liner to further wrap and package the dog pizza. In one embodiment, the pizza is shrink-wrapped using any technique known to those of ordinary skill in the art.

At S150, the pizza and toppings are placed in a cardboard box. The box is similar to pizza delivery boxes, and is substantially square, with a lid that lifts vertically from the closed position, and comprises a plurality of flaps. Those of ordinary skill in the art are familiar with boxes used to deliver pizzas for human consumption and are familiar with their construction and operation.

At S160, method 100 ends.

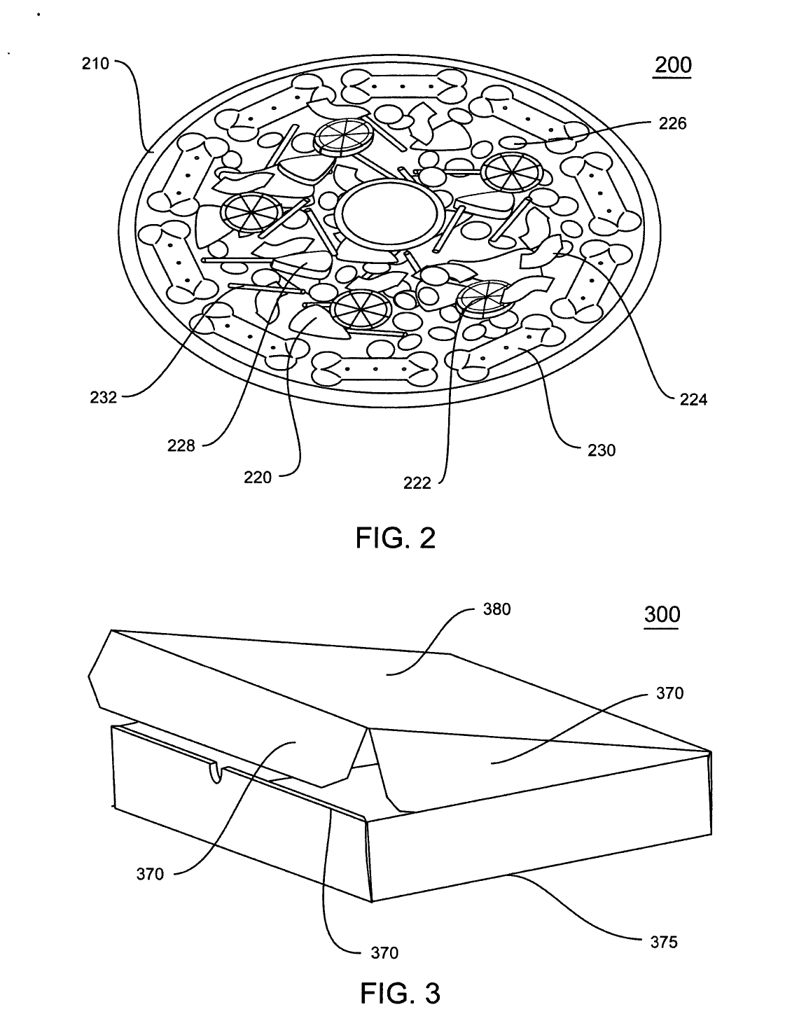

FIG. 2 depicts one embodiment of a dog pizza at 200. Dog pizza 200 comprises crust 210 and toppings 220.

Crust 210 is illustrated with a circular shape, but the invention is not limited to circular crusts. In one embodiment, the crust is an edible treat. In one embodiment of the invention, the crust comprises a non-edible, but dog-friendly treat, such as rawhide or a bone or a bone-like substance. In one embodiment, the crust is a toy, such as a rubber toy, inflatable toy, or another dog toy as would be known to those of skill in the art. In another embodiment, the crust may be a plastic flying disc. In another embodiment of the invention, the crust may comprise a non-edible material such as wicker, plastic, a polymer, wood, or glass. In another embodiment, the crust comprises paper or cardboard. The crust, however, is not intended for human consumption. In another embodiment, the crust is substantially rectangular. In another embodiment, the crust is substantially square. In another embodiment, the crust is another appropriate shape, such as, for example, a triangle, oval or other polygonal shape. In one example, the crust is substantially flat, without raised edges. In another example, the crust is thicker at the outer edge than in the inner portion of the crust, as in a deep-dish, or pan-styled, pizza. In another example, the crust is raised at the outer edge relative to the inner portion of the crust, as in a deep-dish, or pan-styled, pizza. In another embodiment, “themed” pizzas may be produced. In an example, a themed pizza for a Valentine's holiday may comprise a “heart” shaped crust, with or without heart shaped treats. In another example, a Christmas tree shape is used for a Christmas theme. In another example, an egg-shaped crust or egg theme is used for an Easter theme. In another example, a rabbit shape is used for an Easter theme. In another example, a pumpkin shape is used for Halloween. In another example, a red, white and blue pizza is a patriotic theme. In yet another example, a sports theme is used, comprising, for example, a soccer ball, or professional sports team theme.

Toppings 220 comprise a variety of dog treats. As illustrated in FIG. 2, toppings 220 comprise pizza-shaped treats 222, kibbles 224, bits 226, moist chewy chunks 228, milk bones 230, and crunchy dog snacks 232.

In one embodiment, the pizza is a small pizza. In another embodiment, the pizza is a large pizza. In another embodiment, the pizza is a medium pizza. The size of the pizza may be varied to appeal to smaller or larger dogs. For example, the owner of a miniature schnauzer may prefer a smaller sized pizza than the owner of a Great Dane. Furthermore, the color scheme of toppings 220 may be varied as to appeal to different personality, sex, or breeds of dog. For example, a pink box may appeal to the owners of female dogs and a blue box may appeal to the owners of male dogs.

FIG. 3 illustrates another aspect of the invention at 300. Box 300 is a packaging box for dog treats in the form of a pizza not intended for human consumption. Box 300 comprises flaps 370, lid 380 and bottom 375.

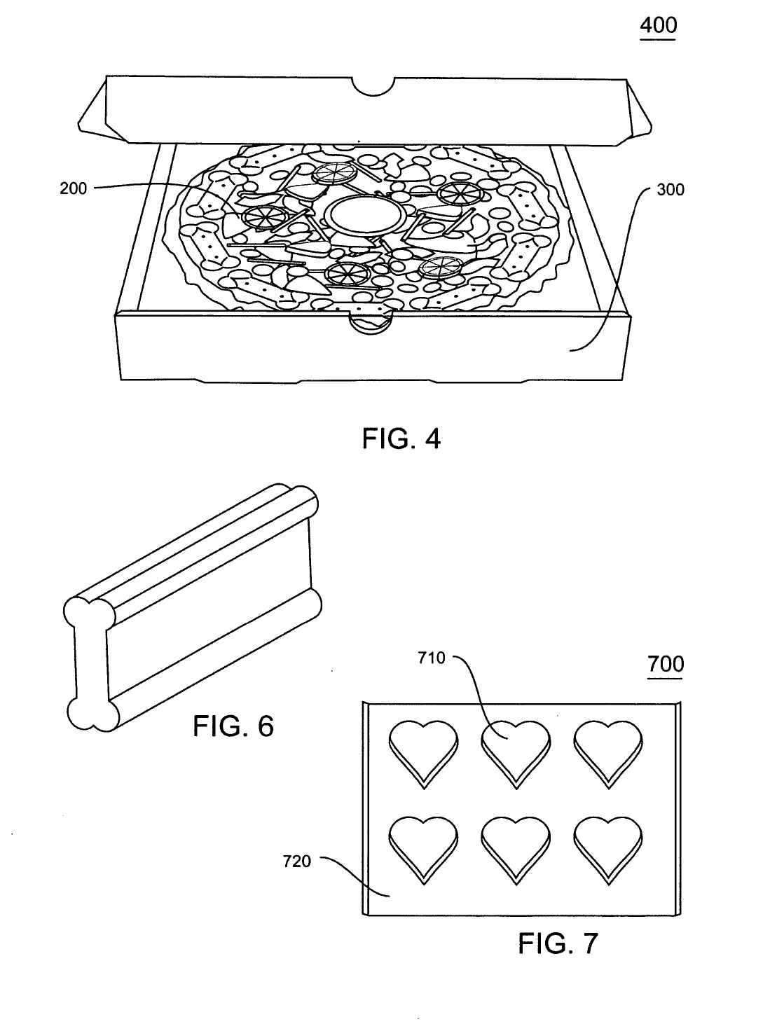

FIG. 4 is an illustration of the pizza of FIG. 2 disposed within the box of FIG. 3 at 400. Dog pizza 400 comprises the box 300 and the pizza 200.

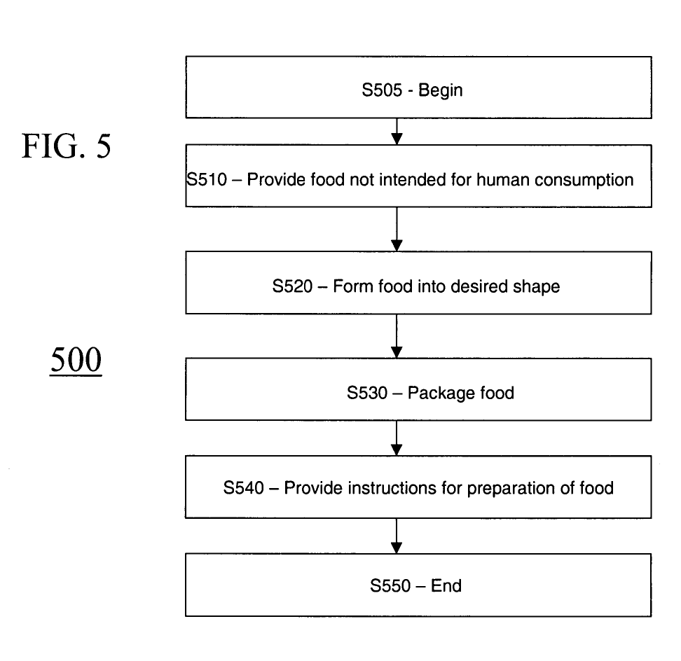

FIG. 5 illustrates a method for presentation and service of food and treats for companions in accordance with the instant invention at 500. Method 500 begins at S505.

At S510, treats not intended for human consumption are provided. In one embodiment of the invention, the treats are one of any number of food substances or treats known to those of ordinary skill in the art.

At S520, the provided treat is shaped into a desired shape. In one embodiment, the desired shape is elongated into a shaped tube with a cross-section of the desired shape such that the elongated treat tube comprises multiple servings and may be sliced to create at least two servings of the treats. In another embodiment, the treats are formed into individual servings shaped with the desired visual appearance. The term “tube” is defined to include both hollow and solid forms.

In one embodiment, the desired shape evokes a “theme.” In an example, a themed treats for a Valentine's holiday may comprise a “heart” shaped treat. In another example, a Christmas tree shape is used to evoke a Christmas theme. In another example, an egg theme is used to evoke an Easter theme. In another example, a rabbit shape is used to evoke an Easter theme. In another example, a pumpkin shape is used to evoke Halloween. In another example, a red, white and blue treat evokes a patriotic theme. In yet another example, a sports theme is used, comprising, for example, a soccer ball, or professional sports team theme.

The size of the treats may be varied to appeal to smaller or larger non-human companions. For example, the owner of a miniature schnauzer may prefer a smaller sized treat than the owner of a Great Dane. Furthermore, the color scheme of the treats may be varied as to appeal to different personality, sex, or species of non-human companions. For example, a pink food may appeal to the owners of female non-human companions and a blue food may appeal to the owners of male non-human companions.

At S530, in one embodiment, the treats are packaged. In one embodiment, an elongated tube comprising multiple servings is wrapped with a protective packaging (as known to those of ordinary skill in the art) and sealed at the ends of the elongated tube. In another embodiment, individual servings of the treats are placed on a tray prior to being inserted into protective packaging. In another embodiment, the tray used comprises individual portions of the tray that are shaped similarly as the treats. Thus, in an embodiment where the treats are shaped to evoke a dog bone, the tray comprises individual cutouts shaped like a dog bone and sized so that the treats may be disposed within the cutout. In another embodiment, where the treats are shaped like a Valentine's heart, the tray comprises heart-shaped cutouts sized to accommodate a valentine's heart shaped treat. In one embodiment, the treats are frozen prior to packaging. In another embodiment, the treats are frozen after packaging and prior to delivery to a user. In this embodiment, the treat may be kept frozen until being further processed by the user. In yet another embodiment, the treats are refrigerated prior to packaging. In another embodiment, the treats are refrigerated after packaging and prior to delivery to a user. In this embodiment, the treat may be kept refrigerated until being further processed by the user.

At S540, instructions for preparing the treats are provided. In one embodiment, the instructions comprise the use of slicing tools to cut an elongated tube into individual servings. In another embodiment, the instructions include thawing the elongated tube of treats before slicing the tube into individual treats. The instructions, in another embodiment, include instructions on heating the treats. In one such example, heating the treats per the instructions results in a crispier food than as packaged. In another such example, heating the treats results in a chewier food than as packaged. In another example, no heating is required. In another example, the instructions include a direction to insert the tray directly into an oven, and in another example, the instructions include a direction to remove the food from the tray prior to insertion in an oven. However, the instructions must require further preparation prior to serving, although those of ordinary skill in the art will recognize that instructions alone cannot mandate user compliance. The instructions include a direction that the treats are not intended for human consumption. In an example, the direction reads “NOT FOR HUMAN CONSUMPTION.”

At S550, method 500 ends.

FIG. 6 illustrates another embodiment of the invention, wherein the treats are packaged as an elongated tube of food not intended as a single serving as described above. The example illustrated in FIG. 6 is shaped like a dog bone, but those of ordinary skill in the art will readily recognize that a multitude of other shapes could be used to practice the invention.

FIG. 7 illustrates another embodiment of the invention, wherein the treats are placed on a tray prior to packaging. In the embodiment illustrated in FIG. 7, the treats 710 are placed into cutouts 720 in the shape of a Valentine's heart, although those of ordinary skill in the art will readily recognize that any shape of cutout could be used, and would be included in the invention.

In one embodiment of the invention, the treats are frozen prior to preparation. For example, the treats are frozen when packaged and sold as a frozen food not intended for human consumption. The instructions for preparing the treats comprise instructions to heat the treats in an oven at a predetermined temperature for a predetermined period of time.

As defined herein, the term “inedible” has a broad definition, and includes items which are not intended for human consumption, and are not strictly edible although may be digestible by pets. For example, rawhide is an inedible item as defined herein, as it rawhide is not intended for human consumption, but pets may ingest rawhide during the process of gnawing on the rawhide. The term “frozen” includes refrigerated.

While the preferred embodiments of the invention have been shown and described, numerous variations and alternative embodiments will occur to those of ordinary skill in the art. Accordingly, it is intended that the invention not be limited to as described, but also encompass the equivalents of the invention described, as well as any improvements which are obvious to those of ordinary skill in the art. Those of ordinary skill in the art will recognize that the methods and product disclosed herein may be readily adapted to appeal to companions other than dogs. Specifically, the method and product may be modified to appeal to cats, birds, hamsters, lizards, snakes or any other pet.

1. A method of presenting food not intended for human consumption, the method comprising:
providing a crust;
arranging a plurality of treats on the crust to form a pizza;
wrapping the pizza; and
packaging the wrapped pizza in a box.

2. The method of claim 1 further comprising:
adding an adhesive filler to the plurality of treats.

3. The method of claim 2 wherein the adhesive filler comprises a wet dog food.

4. The method of claim 1 wherein the crust is inedible.

5. The method of claim 1 wherein the crust is selected from the group consisting of rawhide, treats, bone, rubber toys, plastic flying discs, wicker, plastic, wood, paper, cardboard, and glass.

6. The method of claim 1 wherein the plurality of treats is selected from the group consisting of kibbles, “milk bones,” pupparoni, dog sausages and dog treats shaped like food intended for human consumption.

7. A food item not intended for human consumption comprising:
a crust;
a plurality of treats arranged on the crust; and
a box enclosing the crust and treats.

8. The food item of claim 7 wherein the crust is selected from the group consisting of rawhide, treats, bone, rubber toys, plastic flying discs, wicker, plastic, wood, paper, cardboard, and glass.

9. The food item of claim 7 wherein the plurality of treats is selected from the group consisting of kibbles, “milk bones,” pupparoni, dog sausages and dog treats shaped like food intended for human consumption.

10. A method of packaging treats not intended for human consumption comprises:
providing treats not intended for human consumption;
forming the treats into an elongated food tube with a cross-section of a desired shape such that the elongated food tube comprises multiple servings;
packaging the treats; and
providing instructions for preparation of the treats, the instructions including a direction that the treats are not intended for human consumption.

11. The method of claim 10 wherein packaging the treats comprises placing the treats on a tray.

12. The method of claim 11 wherein the tray has cutouts in the desired shape configured to accept a serving.

13. The method of claim 10 further comprising:
preparing the treats by heating the treats.

14. The method of claim 13 further comprising:
maintaining the packaged treats in a frozen state prior to heating.

15. The method of claim 13 further comprising:
maintaining the packaged treats in a refrigarated state prior to heating.
